(19) United States
(12) Patent Application Publication
(10) Pub. No.: US 2009/0300380 A1
(43) Pub. Date: Dec. 3, 2009

(54) Remote power save service for imaging device

(76) Inventors: William John Vojak, Battle Ground, WA (US); Rabindra Pathak, Vancouver, WA (US)

Correspondence Address: SHARP LABORATORIES OF AMERICA, INC., 1320 PEARL ST., SUITE 228, BOULDER, CO, 80302, US

(21) Appl. No.: 12/154,714

(22) Filed: May 27, 2008

(51) Int. Cl. G06F 1/26

(52) U.S. Cl. 713/310

(57) ABSTRACT

A remote power save service for an imaging device is provided. When the imaging device is awake, a power save controller on the imaging device causes the imaging device to enter a reduced power mode in response to a valid power save request received from a remote power save client. Entry into a reduced power mode by the imaging device is thereby achieved without waiting for timeout and without a need for action on the imaging device front panel. Moreover, where an imaging device supports multiple reduced power modes, a power save controller on the imaging device causes the imaging device to enter the particular one of the reduced power modes indicated in the power save request received from the remote power save client.

### BACKGROUND OF THE INVENTION

The present invention relates to reducing the amount of power wasted by computing devices and, more particularly, to a method and system that enables a remote user to prompt an imaging device to enter into a reduced power mode.

Computing devices, such as imaging devices, consume substantial power. To make these devices more power efficient, manufacturers have equipped these devices with one or more reduced power modes that these devices enter after a period of nonuse. In the reduced power modes, the supply of power to certain components of these devices (e.g. user interface, fuser, processing elements) is cutoff or reduced.

The methods by which known imaging devices enter reduced power modes are limited. Most imaging devices automatically place themselves into a reduced power mode after a period of nonuse. The timeout period depends on the device and can vary anywhere from a few minutes to several hours. On some of these devices, the timeout period is made to vary with time of day (for example, 20 minute timeout period from 6 a.m. to 6 p.m., 5 minute timeout period from 6 p.m. to 6 a.m.). Regardless, in the interval between last use of the device and timeout these devices waste considerable power. The level of waste can be particularly significant at night when an imaging device remains awake after completing a management operation, even though there is little chance the device will receive an imaging job or another management request before timing out.

Some imaging devices also support entry into a reduced power mode through local manual intervention. For example, some imaging devices have a key or button on a front panel of the device that can be actuated by a walkup user to cause the device to enter a reduced power mode before timeout. However, these devices are not known to allow a remote user to prompt the device to enter a reduced power mode by taking action on a remote computer.

### SUMMARY OF THE INVENTION

The present invention, in a basic feature, provides a remote power save service for an imaging device, such as a multifunction printer (MFP). When the imaging device is awake, a power save controller on the imaging device causes the imaging device to enter a reduced power mode in response to a valid power save request received from a remote power save client. Entry into a reduced power mode by the imaging device is thereby achieved without waiting for timeout and without a need for action on the imaging device front panel. Moreover, where an imaging device supports multiple reduced power modes, a power save controller on the imaging device causes the imaging device to enter the particular one of the reduced power modes indicated in the power save request received from the remote power save client.

In one aspect of the invention, an imaging device comprises a network interface and a processor communicatively coupled with the network interface, wherein the imaging device receives on the network interface a remotely generated power save request, and wherein in response to the power save request and under control of the processor a power save controller on the imaging device initiates a power saving sequence.

In some embodiments, the power save controller initiates the power saving sequence after determining that the power save request is serviceable.

In some embodiments, the determination of whether the power save request is serviceable comprises determining whether remote power save is enabled on the imaging device.

In some embodiments, the determination of whether the power save request is serviceable comprises authenticating a user credential carried in the power save request.

In some embodiments, the power saving sequence comprises transitioning by the imaging device to a reduced power mode.

In some embodiments, the reduced power mode is selected from among a plurality of reduced power modes supported on the imaging device.

In some embodiments, the reduced power mode is indicated in the power save request.

In some embodiments, power is inhibited to a front panel of the imaging device while the imaging device is in the reduced power mode.

In some embodiments, power is inhibited to a front panel and an imaging subsystem of the imaging device while the imaging device is in the reduced power mode.

In some embodiments, power is inhibited to a front panel, an imaging subsystem and a processor of the imaging device while the imaging device is in the reduced power mode.

In some embodiments, the power saving sequence comprises aborting an imaging job executing on the imaging device.

In some embodiments, the power saving sequence comprises completing an imaging job executing on the imaging device.

In some embodiments, the power saving sequence comprises completing an imaging job pending in a job queue to which imaging device is communicatively coupled via the network interface.

In some embodiments, under control of the processor the imaging device transmits via the network interface a first power save response indicating a power save request status.

In some embodiments, the power save request is a SOAP message over Hypertext Transport Protocol Secure (HTTPS) power save request. SOAP formerly stood for “Simple Object Access Protocol” but the acronym has been dropped.

In another aspect of the invention, a management device comprises a network interface and a processor communicatively coupled with the network interface, wherein under control of the processor a power save client on the management device transmits via the network interface a power save request, and wherein in response to the power save request the power save client receives via the network interface a first power save response and determines from the first power save response whether the power save request is serviceable.

In some embodiments, the power save request indicates a reduced power mode selected from among a plurality of reduced power modes supported on an imaging device.

In yet another aspect of the invention, a method for remotely prompting an imaging device to enter a reduced power mode comprises the steps of receiving via a network interface a remotely generated power save request and initiating in response to the power save request a power saving sequence on the imaging device.

In some embodiments, the method further comprises the step of determining that the power save request is serviceable.

In some embodiments, the power save request indicates a reduced power mode selected from among a plurality of reduced power modes supported on the imaging device and the power saving sequence comprises transitioning the imaging device to the indicated reduced power mode.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which the invention is operative in some embodiments.

FIG. 2 shows the management device of FIG. 1 in more detail.

FIG. 3 shows the imaging device of FIG. 1 in more detail.

FIG. 4 shows functional elements of the management device of FIG. 1.

FIG. 5 shows functional elements of the imaging device of FIG. 1.

FIG. 6 shows a method performed by the imaging device of FIG. 1 in some embodiments of the invention.

FIG. 7 shows a method performed by the management device of FIG. 1 in some embodiments of the invention.

### DETAILED DESCRIPTION OF A PREFERRED EMBODIMENT

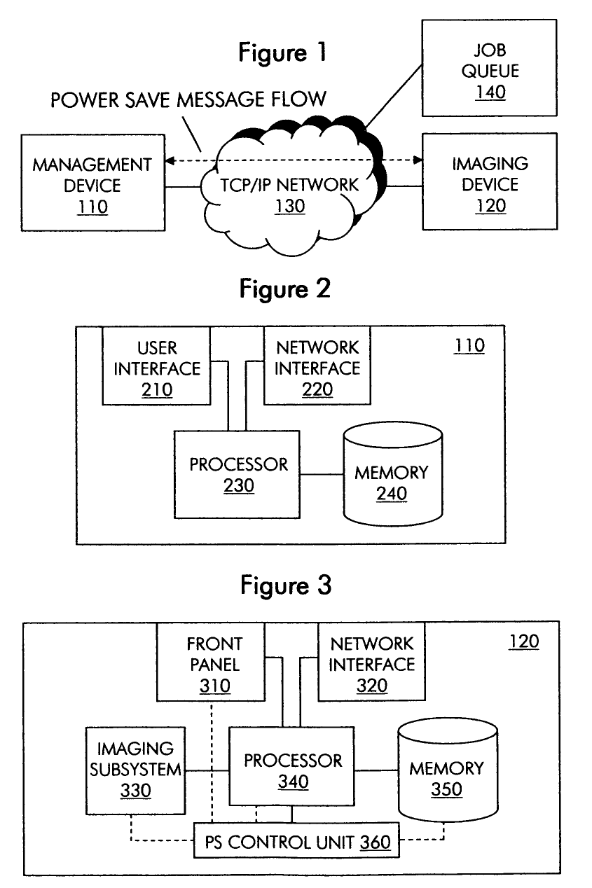

FIG. 1 shows a communication system in which the invention is operative in some embodiments. The system includes a management device 110, an imaging device 120 and a job queue 140 communicatively coupled over a Transport Control Protocol over Internet Protocol (TCP/IP) network 130. Job queue 140 queues imaging jobs that await processing on imaging device 120. In accordance with the principles of the invention, when imaging device 120 is in a full power state (i.e. awake), management device 110 and imaging device 120 conduct a power save message flow in which management device 110 remotely prompts imaging device 120 to enter a reduced power mode by transmitting a power save request to a power save controller executing on imaging device 120. Such a power save request and any initial power save response returned by imaging device 120 are in some embodiments formatted as SOAP messages over HTTPS, although in other embodiments a job control language such as Printer Command Language (PCL) or Postscript (PS), HyperText Markup Language (HTML) with embedded tags, or a proprietary messaging method, may be employed. TCP/IP network 130 may include any number of routers, switches and/or bridges that communicatively couple management node 110 and imaging device 120. In some embodiments, TCP/IP network 130 traverses the public Internet.

FIG. 2 shows management device 110 in greater detail. Management device 110 includes a user interface 210, a network interface 220 and a memory 240, all of which are communicatively coupled with a processor 230. User interface 210 has an input mechanism, such as a keyboard, keypad or touch screen for accepting inputs from a user and an output mechanism, such as a liquid crystal display (LCD) or cathode ray tube (CRT) for displaying outputs to a user. Network interface 220 is a wired or wireless local area network (LAN) interface, such as an Institute of Electrical and Electronics Engineers (IEEE) 802.3- or 802.11-compliant interface, that communicatively couples management device 110 to TCP/IP network 130. Memory 240 includes one or more random access memories (RAM) and one or more read only memories (ROM). Processor 230 executes software installed in memory 240 to carry-out operations on management device 110 including generating and transmitting a power save request in response to a remote power save start prompt received as inputs on user interface 210, processing power save responses received on network interface 220 and outputting power save status messages on user interface 210.

In FIG. 3, imaging device 120 is shown in more detail. Imaging device 120 is in some embodiments an MFP device that supports multiple imaging functions, such as printing, scanning and copying. Imaging device 120 has a front panel 310 for accepting inputs from walkup users and displaying outputs to walkup users. Front panel 310 has an input mechanism, such as buttons and/or a touch screen for accepting inputs from a user and an output mechanism, such as a liquid crystal display (LCD) or light emitting diode (LED) display for displaying outputs to a user. Imaging device 120 also has a network interface 320. Network interface 320 is a wired or wireless LAN interface, such as an IEEE 802.3- or 802.11-compliant interface, that communicatively couples imaging device 120 to TCP/IP network 130. Internal to imaging device 120, front panel 310 and network interface 320 are communicatively coupled with a processor 340, which is also coupled with a memory 350 and an imaging subsystem 330. Imaging subsystem 330 includes, for example, a scan/copy engine having scanner/copier logic, such as one or more integrated circuits (ICs), and an electromechanical section for performing a scanning and copying functions. The electromechanical section may have, for example, a line image sensor mounted on a movable carriage for optically scanning a document under the control of a scanner IC and storing the scanned document into memory 350. Imaging subsystem 330 also includes, for example, a print engine having printer logic, such as one or more ICs, and an electromechanical section for performing printing functions. The electromechanical section may have, for example, a color ink jet head mounted on a movable carriage for printing a document under the control of a printer IC. The electromechanical section may alternatively have a fusing mechanism for heating toner and fusing liquefied toner to paper. While in the illustrated embodiment an imaging device that supports scanning, copying and printing is shown, in other embodiments of the invention an imaging device that supports additional or different imaging-related functions, such as faxing and filing, or a single-function imaging device, may be employed. Memory 350 includes one or more RAM and one or more ROM. Processor 340 executes software installed in memory 350 to carry-out operations on imaging device 120 including processing power save requests received on network interface 320, selectively initiating a power saving sequence on imaging device 120 in response to power save requests and generating and transmitting power save responses on network interface 320 in response to power save requests. Imaging device 120 also has a power supply control unit 360 for regulating the supply of power to front panel 310, imaging subsystem 330, processor 340 and memory 350 to effectuate the current reduced power mode.

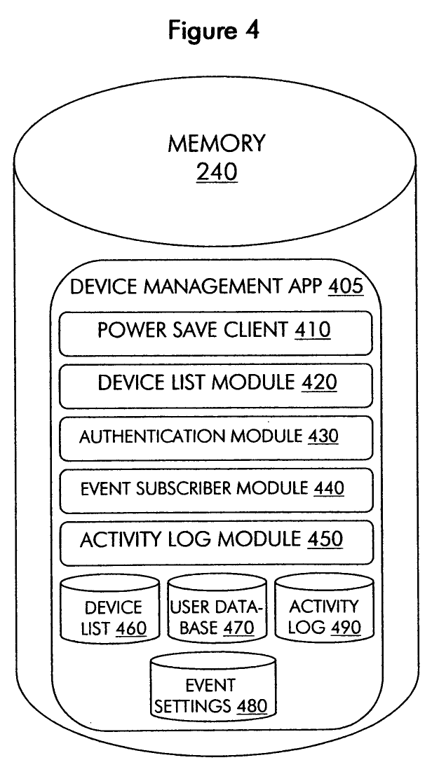

FIG. 4 shows functional elements of management device 110 to include a management application 405. Application 405 is a software program stored in memory 240 and executable by processor 230 to remotely manage one or more imaging devices, including imaging device 120. A user of management device 110 launches and interacts with application 405 through inputs and outputs on user interface 210.

Application 405 includes elements that perform discrete functions relating to a remote power save service. A power save client 410 is invoked by application 405 after a user through inputs on user interface 210 prompts application 405 to make a remote power save attempt. Power save client 410 may be a web services client. Power save client 410 generates and transmits to imaging device 120 via network interface 220 a power save request having information collected from a device list module 420, an authentication module 430 and an event subscriber module 440, which retrieve the information from a device list 460, a user database 470 and event settings 480, respectively. The power save request also indicates one of a plurality of reduced power modes (e.g. standby, sleep, hibernate) supported on imaging device 120 and that has been requested by the user through inputs on user interface 210. Power save client 410 receives from imaging device 120 via network interface 220 and processes power save responses received in response to the power save request. Power save client 410 also causes status messages based on power save responses to be displayed on user interface 210. Power save client 410 also sets and monitors a power save response timer after transmitting the power save request and aborts the remote power save attempt if the timer expires prior to receiving a power save response from imaging device 120, in which case power save client 410 causes a status messages indicating that the remote power save attempt has been aborted to be displayed on user interface 210. In some embodiments, power save client 410, after aborting a remote power save attempt, reattempts remote power save until a predetermined number of unsuccessful attempts have been made. Power save client 410 also causes times and results of power save requests to be logged in activity log 490 through calls to an activity log module 450.

Device list module 420 is called by power save client 410 for a Uniform Resource Locator (URL) or Internet Protocol (IP) address of imaging device 120. Device list module 420 retrieves the URL or IP address from device list 460 and returns the URL or IP address to power save client 410.

Authentication module 430 is called by power save client 410 for one or more user credentials associated with a user of management device 110 that are used by imaging device 120 to verify that the user is authorized to use the remote power save service. Authentication module 430 retrieves the user credentials from user database 470 and returns the user credentials to power save client 410. The user credentials may include, for example, a username and password, or a user certificate. Although user database 470 is shown internal to management device 110, in some embodiments user database 470 may be maintained externally and accessed using Windows security, active directory, Lightweight Directory Access Protocol (LDAP) or other service.

Event subscriber module 440 is called by power save client 410 for an event notification type for reporting events occurring in connection with the remote power save attempt. Event subscriber module 440 retrieves the type from event settings 480 and returns the type to power save client 410. The type may specify reporting of Simple Network Management Protocol (SNMP) trap events or SOAP events, for example. The event notification type is configurable by the user of management device 110 through inputs on user interface 210.

Activity log module 450 is called by power save client 410 to log in activity log 490 remote power save activities, such as times and results of power save attempts.

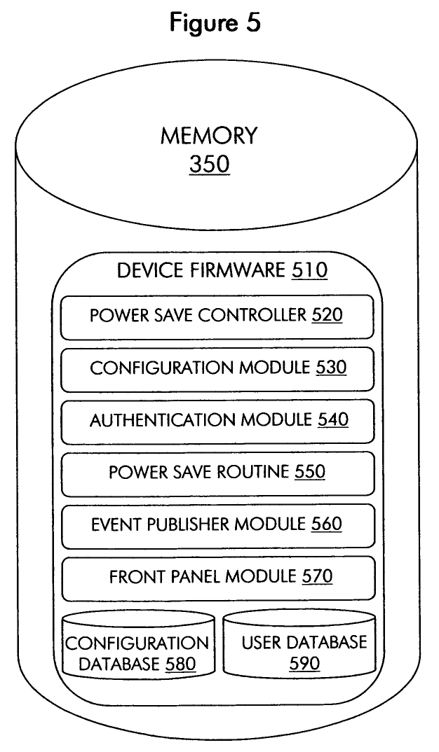

FIG. 5 shows functional elements of imaging device 120 to include device firmware 510. Firmware 510 is embedded software stored in memory 350 and executable by processor 340 to operate and manage imaging device 120.

Firmware 510 has several elements that perform functions relating to the remote power save service. A power save controller 520 is invoked in response to receipt via network interface 320 of a power save request sourced from management device 110. Power save controller 520 may be a web service exposed by imaging device 120. Power save controller 520 processes the power save request and makes an initial determination of whether the power save request is serviceable. Power save controller 520 collects information from a configuration module 530 and an authentication module 540, which access information from a configuration database 580 and a user database 590, respectively, to facilitate the initial determination of whether the power save request is serviceable. Upon making an initial determination that the power save request is serviceable, power save controller 520 calls a power save routine 550 to initiate a power saving sequence. Power save controller 520 also generates and transmits to management device 110 via network interface 320 an initial power save response that indicates whether the power save request is serviceable based on the initial determination. In some embodiments, the power save request and the initial power save response are SOAP message over HTTPS formatted. Power save controller 520 also provides to an event publisher module 560 an event notification type specified in the power save request for reporting events that occur in connection with power save attempt.

Configuration module 530 is called by power save controller 520 to verify that remote power save is presently enabled on imaging device 120. Configuration module 530 checks a remote power save setting in configuration database 580 to determine whether remote power save is presently enabled or disabled. If the setting indicates that remote power save is enabled, configuration module 530 reports that finding to power save controller 520. If the setting indicates that remote power save is disabled, configuration module 530 reports that finding to power save controller 520. The remote power save setting may be configured through inputs made by a human user on front panel 310. When such inputs are received, front panel module 570 calls configuration module 530, which saves the remote power save setting in configuration database 580. Configuration database 580 may be a relational database or a file saved on a hard disk, for example.

Authentication module 540 is called by power save controller 520 to verify that the user who is requesting entry by imaging device 120 into a reduced power mode is authorized for that purpose. Authentication module 540 compares for a match one or more user credentials carried in the power save request with user credentials stored in user database 590. The compared user credentials may include, for example, a username and password or a user certificate. If a match is found, authentication module 540 reports a successful authentication to power save controller 520. If no match is found, authentication module 540 reports an authentication failure to power save controller 520.

Power save routine 550 initiates a power saving sequence on imaging device 120 when called by power save controller 520. The power saving sequence transitions imaging device 120 from a full power mode to a reduced power mode indicated in the power save request. Under control of power save routine 550, the power saving sequence may proceed in various ways. In some embodiments, imaging device 120 blocks acceptance of imaging jobs pending in job queue 140, aborts management operations executing on imaging device, 120, aborts imaging jobs executing on imaging device 120, and then enters the reduced power mode. In other embodiments, imaging device 120 blocks acceptance of imaging jobs pending in job queue 140, completes management operations executing on imaging device, 120, aborts imaging jobs executing on imaging device 120, and then enters the reduced power mode. In yet other embodiments, imaging device 120 blocks acceptance of imaging jobs pending in job queue 140, completes management operations executing on imaging device, 120, completes imaging jobs executing on imaging device 120, and then enters the reduced power mode. In still other embodiments, imaging device 120 completes management operations executing on imaging device, 120, completes imaging jobs executing on imaging device 120, completes imaging jobs pending in job queue 140, and then enters the reduced power mode. In embodiments where imaging device 120 blocks acceptance of imaging jobs pending in job queue, imaging device 120 may flush job queue 140. Moreover, in embodiments where imaging device 120 does not complete all imaging jobs executing on imaging device 120 and pending in job queue 140, imaging device 120 may notify by email or instant message users whose jobs will not be completed. Power save routine 550 issues a command to power supply control unit 360 indicating the reductions in power required to enter the reduced power mode, which reductions are made by power supply control unit 360.

Imaging device 120 supports three discrete reduced power modes: Standby, sleep and hibernate. The power save request identifies which one of these reduced power modes should be entered. In standby mode, power is inhibited to front panel 130 but imaging subsystem 330 and processor 340 remain powered. Standby mode saves some power while enabling relatively quick return to a fully operational state. Moreover, management tasks such as gathering statistics, responding to network discovery queries and reviewing imaging jobs can be performed while in standby mode. In sleep mode, power is inhibited to front panel 310 and imaging subsystem 330 while processor 340 remains powered. Sleep mode saves substantial power. Moreover, management tasks like gathering statistics, responding to network discovery queries and reviewing imaging jobs can be performed while in sleep mode. With regard to hibernate mode, device status is stored in a nonvolatile area of memory 350, after which power is inhibited to front panel 310, imaging subsystem 330 and processor 340. Network interface 220 remains powered to enable subsequent wakeup of imaging device 120. Among the three reduced power modes, hibernate mode conserves the most power.

Event publisher module 560 is informed by power save controller 520 of the event notification type specified in the power save request for reporting events occurring in connection with the power save attempt. The type may specify SNMP or SOAP event reporting, for example. Event publisher module 560 monitors for events of the specified type and generates and transmits to management device 110 via network interface 320 supplemental power save responses having an updated power save request status indicative of serviceability of the power save request based on such events. Supplemental power save responses are formatted in conformance with the specified event notification type. For example, if the specified type is SOAP event reporting, supplemental power save responses may be formatted as SOAP messages. If the specified type is SNMP event reporting, supplemental power save responses may be formatted as SNMP trap messages.

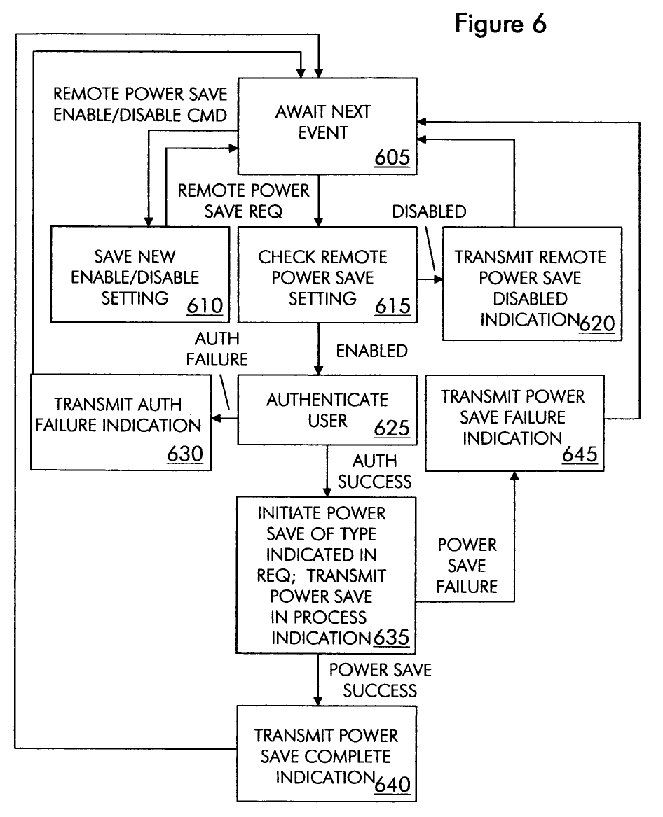

Turning to FIG. 6, a method performed by imaging device 120 in some embodiments of the invention is shown. Imaging device 120 listens for the next event (605). If the next event is a remote power save enable or disable command input on front panel 310, configuration module 530 saves the new enable or disable setting in configuration database 590 (610) and imaging device 120 awaits the next event (605). If the next event is a power save request received from management node 110 on network interface 320, power save controller 520 calls configuration module 530 to verify that remote power save is presently enabled (615). If configuration module 530 determines that remote power save is presently disabled, configuration module 530 reports disabled status to power save controller 520 and power save controller 520 returns to management node 110 a power save response indicating that remote power save is disabled (620) and imaging device 120 awaits the next event (605). If, however, configuration module 530 determines that remote power save is presently enabled, configuration module 530 reports enabled status to power save controller 520 and power save controller 520 calls authentication module 540 to verify user credentials carried in the power save request (625). If authentication module 540 is unable to verify the user credentials, authentication module 540 reports an authentication failure to power save controller 520 and power save controller 520 returns to management node 110 a power save response indicating an authentication failure (630) and imaging device 120 awaits the next event (605). If, on the other hand, authentication module 540 is able to verify the user credentials, authentication module 540 reports authentication success to power save controller 520 and power save controller 520 calls power save routine 550 to initiate a power saving sequence of the type (e.g. standby, sleep, hibernate) indicated in the power save request and transmits to management node 110 an initial power save response indicating that remote power save is in process (635). Power save controller 520 also informs event publisher module 560 of the event notification type specified in the power save request and event publisher module 560 monitors for such events. The power saving sequence proceeds and eventually either fails, in which case event publisher module 560 transmits to management node 110 a supplemental power save response formatted in conformance with the event notification type indicating a power save failure (645) and imaging device 120 awaits the next event (605), or succeeds, in which case event publisher module 560 transmits to management node 110 a supplemental power save response formatted in conformance with the event notification type indicating that imaging device 120 has entered the requested reduced power mode (640) and imaging device 120 awaits the next event (605).

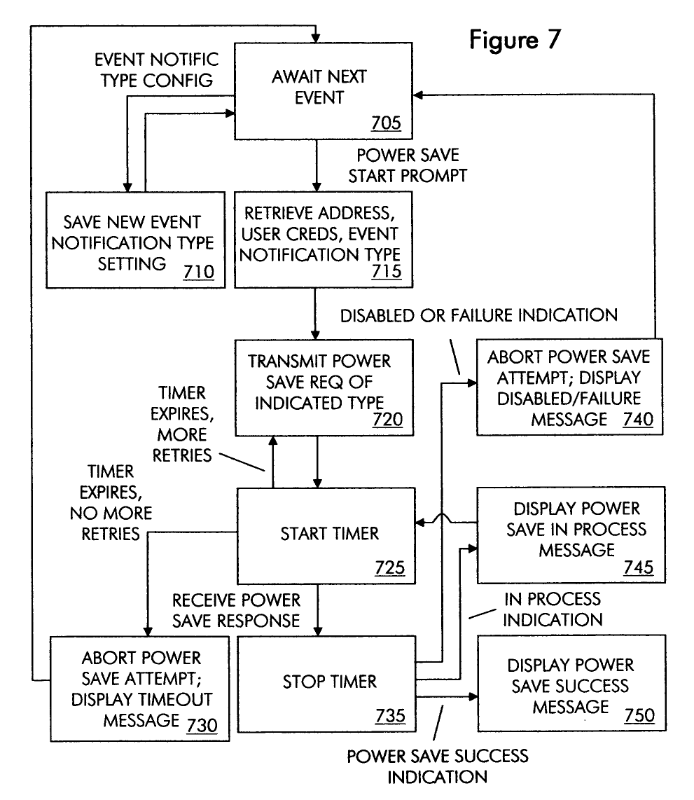

FIG. 7 shows a method performed by management device 110 in some embodiments of the invention. The flow begins with management device 110 awaiting the next event (705). If the next event is an event notification type configuration command input on user interface 210, event subscriber module 440 saves the new event notification type in event settings 480 (710) and management device 110 awaits the next event (705). If the next event is a remote power save start prompt input on user interface 210, power save client 410 calls device list module 420 for a URL or IP address of imaging device 120, calls authentication module 430 for user credentials, calls event subscriber module 440 for an event notification type (715) and generates a power save request addressed to imaging device 120 and carrying the user credentials, event notification type and the reduced power mode mode type (e.g. standby, sleep, hibernate) indicated in the power save start prompt. Power save client 410 transmits the power save request to imaging device 120 via network interface 220 (720) and starts a power save response timer (725). Eventually, either a power save response is received or the power save response timer expires. If the timer expires, power save client 410 aborts the remote power save attempt (after exhausting the configured number of retries) and causes to be displayed on user interface 210 a status message indicating that the attempt has failed (730) and management device 110 awaits the next event (705). If, on the other hand, a power save response is received before the timer expires, power save client 410 stops the timer (735) and analyzes the power save response. If the power save response indicates that remote power save is disabled or that the attempt has failed (e.g. authentication failure, error condition, etc.), power save client 410 aborts the remote power save attempt and causes to be displayed on user interface 210 a status message indicating that the attempt has failed and the reason (740) and management device 110 awaits the next event (705). If, on the other hand, the power save response indicates that remote power save is in process, power save client 410 causes to be displayed on user interface 210 a status message indicating that remote power save is in process (745) and starts a power save response timer (725). If the power save response indicates that remote power save is complete, power save client 410 causes to be displayed on user interface 210 a status message indicating that the remote power save attempt is has been successful (750).

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. An imaging device, comprising:
a network interface; and
a processor communicatively coupled with the network interface, wherein the imaging device receives on the network interface a remotely generated power save request, and wherein in response to the power save request and under control of the processor a power save controller on the imaging device initiates a power saving sequence.

2. The imaging device of claim 1, wherein the power save controller initiates the power saving sequence after determining that the power save request is serviceable.

3. The imaging device of claim 2, wherein the determination of whether the power save request is serviceable comprises determining whether remote power save is enabled on the imaging device.

4. The imaging device of claim 2, wherein the determination of whether the power save request is serviceable comprises authenticating a user credential carried in the power save request.

5. The imaging device of claim 1, wherein the power saving sequence comprises transitioning by the imaging device to a reduced power mode.

6. The imaging device of claim 5, wherein the reduced power mode is selected from among a plurality of reduced power modes supported on the imaging device.

7. The imaging device of claim 5, wherein the reduced power mode is indicated in the power save request.

8. The imaging device of claim 5, wherein power is inhibited to a front panel of the imaging device while the imaging device is in the reduced power mode.

9. The imaging device of claim 5, wherein power is inhibited to a front panel and an imaging subsystem of the imaging device while the imaging device is in the reduced power mode.

10. The imaging device of claim 5, wherein power is inhibited to a front panel, an imaging subsystem and a processor of the imaging device while the imaging device is in the reduced power mode.

11. The imaging device of claim 1, wherein the power saving sequence comprises aborting an imaging job executing on the imaging device.

12. The imaging device of claim 1, wherein the power saving sequence comprises completing an imaging job executing on the imaging device.

13. The imaging device of claim 1, wherein the power saving sequence comprises completing an imaging job pending in a job queue to which imaging device is communicatively coupled via the network interface.

14. The imaging device of claim 1, wherein under control of the processor the imaging device transmits via the network interface a first power save response indicating a power save request status.

15. The imaging device of claim 1, wherein the power save request is a SOAP message over Hypertext Transport Protocol Secure (HTTPS) power save request.

16. A management device, comprising:
a network interface; and
a processor communicatively coupled with the network interface, wherein under control of the processor a power save client on the management device transmits via the network interface a power save request, and wherein in response to the power save request the power save client receives via the network interface a first power save response and determines from the first power save response whether the power save request is serviceable.

17. The management device of claim 16, wherein the power save request indicates a reduced power mode selected from among a plurality of reduced power modes supported on an imaging device.

18. A method for remotely prompting an imaging device to enter a reduced power mode, comprising the steps of:
receiving via a network interface a remotely generated power save request; and
initiating in response to the power save request a power saving sequence on the imaging device.

19. The method of claim 18, further comprising the step of determining that the power save request is serviceable.

20. The method of claim 18, wherein the power save request indicates a reduced power mode selected from among a plurality of reduced power modes supported on the imaging device and the power saving sequence comprises transitioning the imaging device to the indicated reduced power mode.
